(19) United States
(12) Patent Application Publication
(10) Pub. No.: US 2017/0150833 A1
(43) Pub. Date: Jun. 1, 2017

(54) Miniaturized Sports Memorabilia and Collectibles

(71) Applicant: MiniGear, LLC, Odenton, MD (US)

(72) Inventor: William L. HARMON, Odenton, MD (US)

(21) Appl. No.: 14/954,890

(22) Filed: Nov. 30, 2015

(51) Int. Cl. A47G 1/12; A47F 3/00; A47F 7/22; G09F 19/00

(52) U.S. Cl. CPC A47G 1/12; G09F 19/00; A47F 3/005; A47F 7/22

(57) ABSTRACT

A miniature sports jersey display includes a frame having at least one pane of clear glass, a miniature sports jersey encased and displayed in the frame and viewable through the at least one pane of clear glass, the miniature sports jersey being a miniaturized version of a full-size sports jersey of an athlete, and a plaque adhered to the display bearing an autograph signature of the athlete.

### FIELD

The present disclosure relates to the field of sports memorabilia, and in particular miniaturized sports memorabilia that provide space-saving benefits in displaying these items.

### BACKGROUND

Sports fans often collect sports memorabilia of their favorite sports teams and players for display in their homes. The sports memorabilia marketplace today is a $5 billion dollar global market, with $1 billion of which attributable to the United States. From baseball cards to autographs to signed jerseys, millions of collectors are spending substantial money on these keepsakes. One commonly collected item is the sports jerseys of favorite football, baseball, basketball, and hockey players at the high school, collegiate, and professional levels. However, displaying these sports jerseys can sometimes present a problem.

### BRIEF DESCRIPTION OF THE DRAWINGS

FIG. 1 is an illustration of a full-size sports jersey with its miniaturized version encased in a frame with an autograph plaque.

### DETAILED DESCRIPTION

Sports fans commonly collect sports memorabilia or collectibles of favorite athletes playing for their favorite sports teams. As understood in the industry, items that have been signed by an athlete are considered memorabilia when the signature has been certified by a reputable distributor. Replica and authentic sports products that are unsigned, or are signed but not authenticated, are considered collectibles. Sports jerseys are popular collected items and are often displayed in frames or shadow boxes and hung on the wall. However, for an enthusiastic sports fanatic, his/her collection may quickly overwhelm the space available on the walls of the den, game room, or man/woman cave.

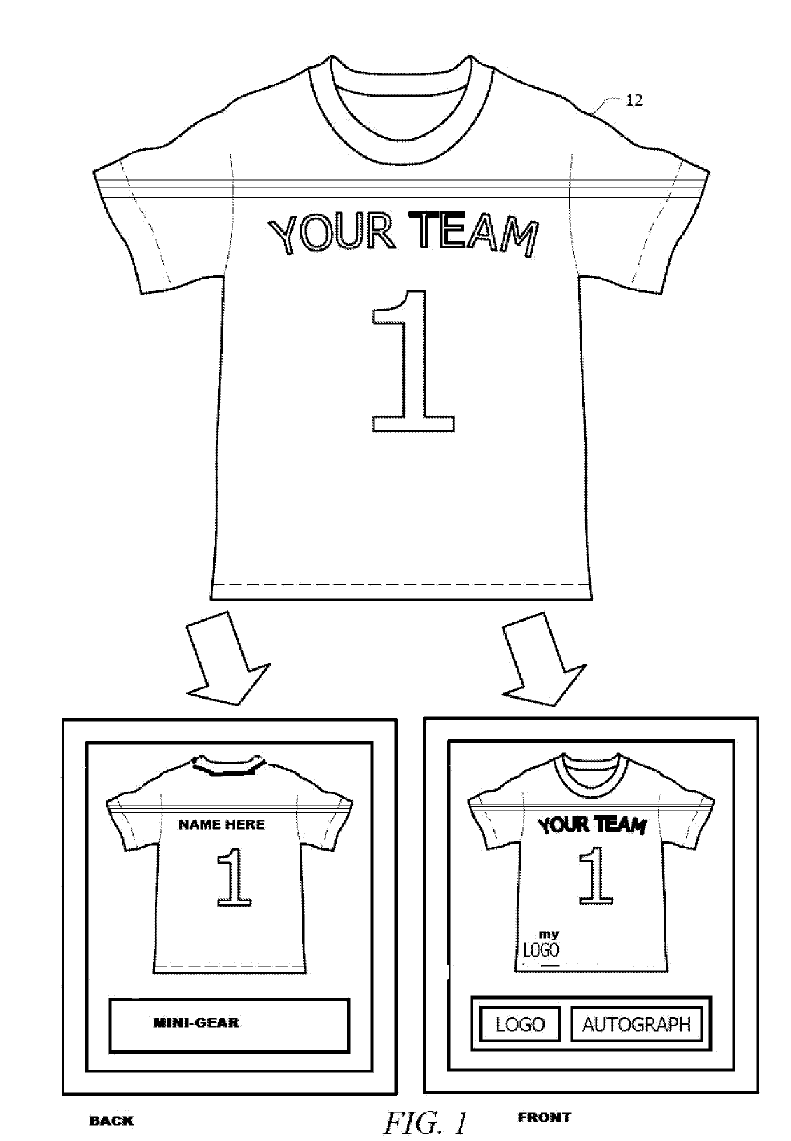

FIG. 1 is an illustration of a full-size sports jersey 12 with its miniaturized version 14 encased in a frame 18 with an autograph plaque 16. The full-size sports jersey 12 may be any team garment worn by an athlete of any favorite sport. Instead of or in addition to collecting the full-size sports jersey, a fan may display a miniaturized version 14 of the same sports jersey stored and encased in a frame 18 that protects the miniature sports jersey as well as provide a clear unimpeded view of the garment. The miniature sports jersey 14 may be at least one-quarter (¼) the size of the full-size jersey, for example, so that the amount of space needed to display the item is minimized. A collection of miniature sports jerseys can be arranged and hung on a wall without overwhelming the entire wall.

The miniature sports jersey 14 may be attached to a backboard 20 that forms a backdrop for the item. The backboard may be constructed of a cardboard or wooden board covered in a fabric or other material that is of a color compatible or complementary with the sports jersey. Alternatively, the sports jersey may be sandwiched between two clear panes of glass that are held by the frame 18, so that the jersey can be hung or displayed with both the front and back sides of the jersey visible, as shown in FIG. 1. In addition, a plaque 16 may be adhered to the backboard 20 or the glass that overlays the frame 18. The plaque 16 may incorporate a team logo (or another graphic element) and the athlete's signature on one side and another graphic or logo on the reverse side, also visible through the back pane of glass. Alternatively, the logo may be the logo of the manufacturer of the miniaturized sports memorabilia and collectibles. The plaque 16 may additionally or alternatively note information significant to the athlete or sports team, such as the game day the athlete worn the full-size version of this miniaturized sports jersey in the fan's collection, the game day the athlete set a record, the athlete's stats, the date and stadium of a big game (e.g., a bowl game) in which the athlete participated, etc.

The frame or shadow box may be square, rectangular, or of any suitable shape, and be constructed of any suitable material, including wood, metal, plastic, a composite material, etc. The plaque 16 may be constructed of paper, cardboard, wood, metal, stone, plastic, a composite material, or any suitable material. The logo can be printed, engraved, or deposited indelibly on the plaque 16 in any suitable conventional manner. Although an autograph signature is preferably authentic and applied by the athlete using a permanent marker, it may also be printed, engraved, or deposited indelibly on the plaque 16 in a suitable conventional manner.

Although not shown explicitly, the same idea described herein may be applied to other types of memorabilia and collectibles. For example, duplicate miniature versions of the entire athletic uniform, helmets, shoes, sports equipment, etc. can also be displayed in the same space-saving manner. In this manner, the collector may store the full-size item in safe storage so that it does not fade, get damaged, or is in danger of theft. More importantly, the collector can still proudly display the miniaturized version of the memorabilia and collectible, but in a space-saving and aesthetically-pleasing manner.

The features of the present invention which are believed to be novel are set forth below with particularity in the appended claims. However, modifications, variations, and changes to the exemplary embodiments described above will be apparent to those skilled in the art, and the miniaturized sports memorabilia and collectibles described herein thus encompasses such modifications, variations, and changes and are not limited to the specific embodiments described herein.

What is claimed is:

1. A miniature sports jersey display comprising:
a frame having at least one pane of clear glass;
a miniature sports jersey encased and displayed in the frame and viewable through the at least one pane of clear glass, the miniature sports jersey being a miniaturized version of a full-size sports jersey of an athlete; and
a plaque adhered to the display bearing an autograph signature of the athlete.

2. The miniature sports jersey display of claim 1, wherein the frame includes two panes of clear glass disposed on front and back sides of the miniature sports jersey.

3. The miniature sports jersey display of claim 1, wherein the plaque comprises a team logo and an autograph signature of the athlete.

4. The miniature sports jersey display of claim 1, wherein the plaque further comprises information about the athlete.

5. The miniature sports jersey display of claim 1, wherein the frame includes a backboard upon which the miniature sport jersey is securely attached.

6. The miniature sports jersey display of claim 5, wherein the plaque is adhered to the backboard.

7. The miniature sports jersey display of claim 1, wherein the miniature sports jersey is at least one-quarter (¼) the size of the full-size sports jersey.

8. A miniature sports collectible display comprising:
a frame having at least one pane of clear glass;
a miniature sports collectible encased and displayed in the frame and viewable through the at least one pane of clear glass, the miniature version of the sports collectible being a miniaturized version of a full-size sports collectible associated with an athlete; and
a plaque adhered to the display bearing an autograph signature of the athlete.

9. The miniature sports collectible display of claim 8, wherein the frame includes two panes of clear glass disposed on front and back sides of the miniature sports collectible.

10. The miniature sports collectible display of claim 8, wherein the plaque comprises a team logo and an autograph signature of the athlete.

11. The miniature sports collectible display of claim 1, wherein the plaque further comprises information about the athlete.

12. The miniature sports collectible display of claim 1, wherein the frame includes a backboard upon which the miniature sport collectible is securely attached.

13. The miniature sports collectible display of claim 12, wherein the plaque is adhered to the backboard.

14. The miniature sports collectible display of claim 1, wherein the miniature sports collectible is at least one-quarter (¼) the size of the full-size sports collectible.

15. A miniature sports jersey display comprising:
a rectangular frame having at least one pane of clear glass;
a miniature sports jersey encased and displayed in the frame and viewable through the at least one pane of clear glass, the miniature sports jersey being at least an one-quarter (¼) miniaturized version of a full-size sports jersey associated with an athlete; and
a plaque adhered to the display bearing an autograph signature of the athlete.

16. The miniature sports jersey display of claim 15, wherein the frame includes two panes of clear glass disposed on front and back sides of the miniature sports jersey.

17. The miniature sports jersey display of claim 15, wherein the plaque comprises a team logo and an autograph signature of the athlete.

18. The miniature sports jersey display of claim 15, wherein the plaque further comprises statistical information about the athlete.

19. The miniature sports jersey display of claim 15, wherein the frame includes a backboard upon which the miniature sport jersey is securely attached.

20. The miniature sports jersey display of claim 19, wherein the plaque is adhered to the backboard.
